(19) United States
(12) Patent Application Publication
(10) Pub. No.: US 2012/0069565 A1
(43) Pub. Date: Mar. 22, 2012

(54) LIGHT-EMITTING DEVICE AND IMAGE DISPLAY APPARATUS USING THE SAME

(75) Inventor: Kazuya Nobayashi, Tokyo (JP)

(73) Assignee: CANON KABUSHIKI KAISHA, Tokyo (JP)

(21) Appl. No.: 13/230,183

(22) Filed: Sep. 12, 2011

(30) Foreign Application Priority Data
Sep. 21, 2010 (JP) 2010-210904

(51) Int. Cl. F21V 5/00

(52) U.S. Cl. 362/235; 362/257

(57) ABSTRACT

A light-emitting device includes a light-emitting layer and a fine structure layer that opposes the light-emitting layer, and light generated in the light-emitting layer passes through the fine structure layer. In the light-emitting device, the fine structure layer includes a plurality of first medium portions and a second medium that has a different refractive index from a refractive index of the first medium, and the plurality of first medium portions are each surrounded by the second medium in an in-plane direction of the fine structure layer. In the light-emitting device, each first medium portion is formed to have a rotated ellipsoidal shape, which has a major axis extending in a direction perpendicular to a surface opposite the light-emitting layer, and is defined by a path of an ellipse rotated about the major axis as a rotation axis.

### BACKGROUND OF THE INVENTION

1. Field of the Invention

The present invention relates to a light-emitting device and an image display apparatus using the light-emitting device.

2. Description of the Related Art

There is a demand for light-emitting devices that have a large area and improved efficiency in extracting light generated in a light-emitting layer to an external region (light extraction efficiency) and that are fabricated at a low cost.

In order to improve light extraction efficiency of a light-emitting device, it is important to decrease loss caused when light generated in a light-emitting layer is extracted to an external region. For example, in a light-emitting device having a light-emitting layer provided on a substrate (front plate), part of the light emitted by the light-emitting layer is attenuated (loss) due to total internal reflection occurring at an interface between the light-emitting layer and the front plate. This loss occurs because, when light propagates from a medium having high refractive index (for example, a light-emitting layer or front plate) towards a medium having low refractive index (for example, an external region), light that propagates at an angle greater than the critical angle undergoes total internal reflection and is confined in the medium having high refractive index. The confined light is not extracted to the medium having low refractive index, and accordingly, light extraction efficiency is decreased.

In order to decrease losses caused by total internal reflection and increase light extraction efficiency, a technology is known in which a fine structure is provided between layers formed of media having different refractive indices from each other (for example, between the light-emitting layer and the front plate). By diffracting light generated in the light-emitting layer using the fine structure, the amount of light that propagates at an angle greater than the critical angle is decreased and the amount of light that propagates at an angle smaller than or equal to the critical angle is increased. Thus, light extraction efficiency is improved.

Japanese Patent Laid-Open No. 2001-230069 discloses an example of the technology in which a fine structure is provided between layers formed of media having different refractive indices. Specifically, it proposes an image display apparatus in which a plurality of light-emitting portions 800 having a structure illustrated in FIG. 7 are arranged. The light-emitting portion 800 illustrated in FIG. 7 includes a pair of electrodes 805 and 803, a light-emitting layer 804, a highly refractive layer 802 formed of a medium having a refractive index higher than that of the light-emitting layer 804, and a front plate 806. In addition, a fine structure 801 is disposed between the front plate 806 and the highly refractive layer 802. The fine structure 801 has a periodical structure formed by fine balls (spheres) arranged in a surface parallel to the front plate 806. The fine structure 801 causes light 809 generated in the light-emitting layer 804 to diffract into rays of light 810 and 811, thereby increasing light 810 that propagates at an angle smaller than or equal to the critical angle. Thus, light extraction efficiency is purportedly improved in comparison to a case in which the fine structure 801 is not used.

However, the related-art structure disclosed in Japanese Patent Laid-Open No. 2001-230069 causes diffracted light 811 to propagate at an angle greater than the critical angle, whereby light 811 is lost within the front plate 806 due to total internal reflection. Accordingly, further improvement of efficiency in extracting light is highly desirable.

### SUMMARY OF THE INVENTION

The present invention that solves the above-described problem provides a light-emitting device that includes a light-emitting layer and a fine structure layer that opposes the light-emitting layer, and light generated in the light-emitting layer passes through the fine structure layer. In the light-emitting device, the fine structure layer includes a plurality of first medium portions and a second medium that has a different refractive index from a refractive index of the first medium, and the plurality of first medium portions are each surrounded by the second medium in an in-plane direction of the fine structure layer. In the light-emitting device, each first medium portion is formed to have a rotated ellipsoidal shape, which has a major axis extending in a direction perpendicular to a surface opposite the light-emitting layer, and is defined by a path of an ellipse rotated about the major axis as a rotation axis.

The light-emitting device according to the present invention achieves high light extraction efficiency.

Further features of the present invention will become apparent from the following description of exemplary embodiments with reference to the attached drawings.

### BRIEF DESCRIPTION OF THE DRAWINGS

FIG. 1 is a sectional view of a light-emitting device according to an embodiment.

FIGS. 2A and 2B illustrate part of a fine structure layer according to the embodiment.

FIG. 3 illustrates a relationship between light extraction efficiency and ellipticity of the light-emitting device according to the embodiment.

FIG. 4 is a sectional view illustrating part of an image display apparatus including a plurality of the light-emitting devices according to the embodiment.

FIGS. 5A to 5F illustrate processes of fabricating the light-emitting device according to the embodiment.

FIGS. 6A to 6D illustrate processes of fabricating the light-emitting device of a second example.

FIG. 7 illustrates a structure of a related-art light-emitting device.

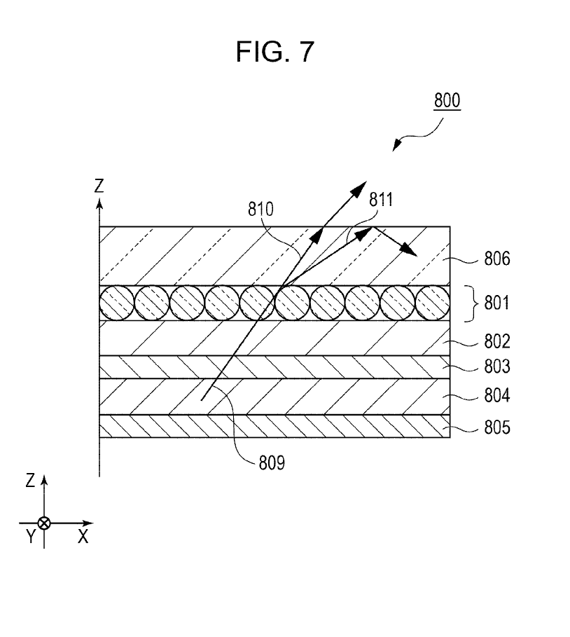

### DESCRIPTION OF THE EMBODIMENTS

An embodiment according to the present invention will be described below with reference to the drawings.

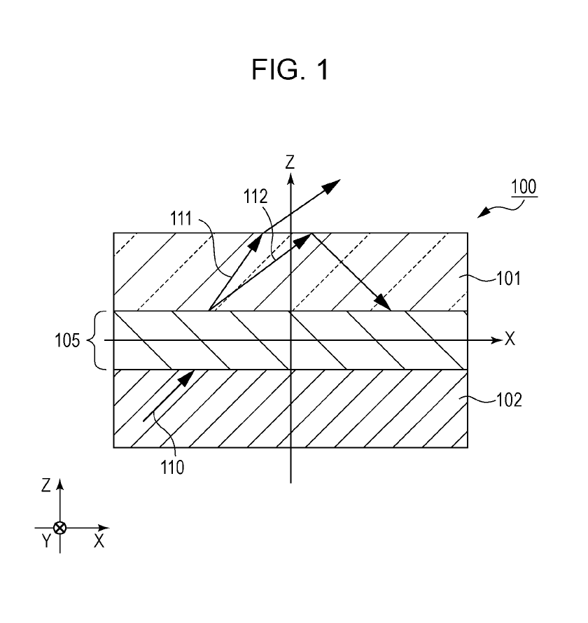

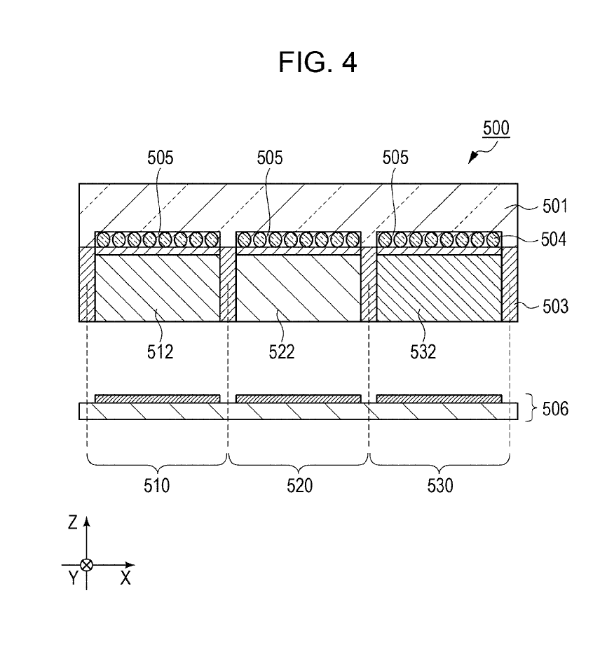

FIG. 1 is an outline view of a light-emitting device 100 according to the present embodiment. The light-emitting device 100 includes a light-emitting layer 102 and a fine structure 105 that serves as a fine structure layer. In a suitable embodiment, the light-emitting device 100 further includes a front plate 101 and an excitation source (shown in FIG. 4). In the embodiment illustrated in FIG. 1, the fine structure 105 is disposed between the front plate 101 and the light-emitting layer 102 so as to oppose the light-emitting layer 102 at an interface between the light-emitting layer 102 and the front plate 101. The light-emitting layer 102 is formed of, for example, a film including a phosphorus material. The light-emitting layer generates light at a center wavelength in the visible wavelength band of 350 to 800 nm. The fine structure 105 as the fine structure layer is a structure through which the light generated in the light-emitting layer 102 passes. The fine structure 105 includes two or more media having respective refractive indices different from each other and has a refractive index distribution in an xy in-plane direction, which is the in-plane direction of the fine structure layer.

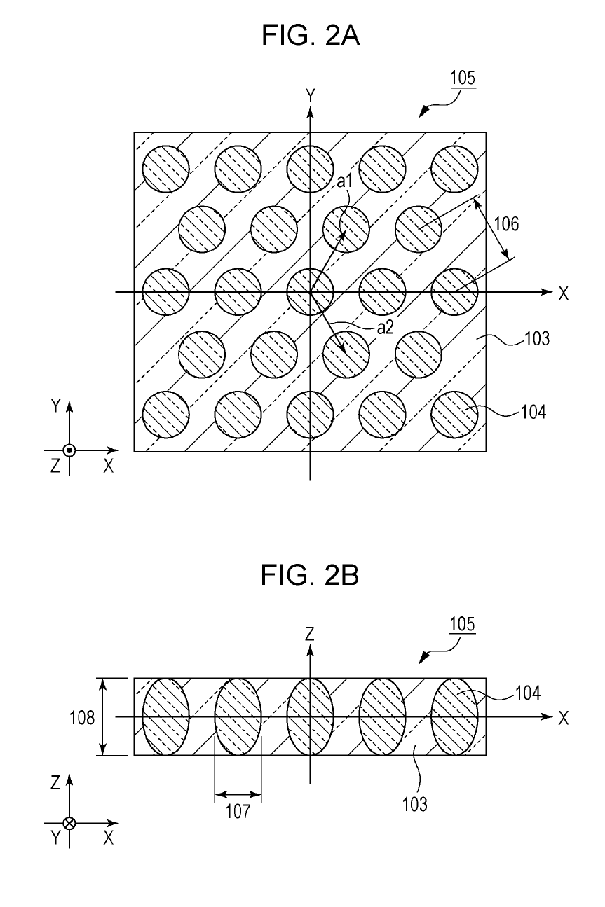

FIGS. 2A and 2B illustrates an example of the fine structure 105 as the fine structure layer. FIGS. 2A and 2B are sectional plane views respectively illustrating an xy-sectional plane viewed towards the positive (+z) z-direction and an xz-sectional plane viewed from the positive (+y) y-direction of the fine structure 105. The fine structure 105 includes ellipsoidal-shaped elliptical spherical structures 104 formed of a first medium (first material) and a region 103 formed of a second medium (second material). The second medium has a refractive index different from that of the first medium, and the region 103 is disposed so as to surround the elliptical spherical structures 104 formed of the first medium. The ellipsoidal-shaped elliptical spherical structures 104 formed of the first medium are disposed so that their major axes extend in the z-direction, which is a direction perpendicular to a surface of the front plate 101 that opposes the light-emitting layer 102. The elliptical spherical structures 104 formed of the first medium are disposed in a staggered manner such that the center of gravity of each elliptical spherical structure 104 is positioned at a lattice point (vertex) of a triangular lattice in the xy-plane. Specifically, referring to FIG. 2A, vectors a1 and a2 are fundamental vectors of the triangular lattice and are expressed as follows:

a1=(0.5a, √3a/2, 0)

a2=(0.5a, −√3a/2, 0).

The triangular lattice has lattice points at positions expressed by a sum of the fundamental vectors a1 and a2 and a difference between the fundamental vectors. Here, the length of a lattice period 106 is given by distance a.

Referring back to FIG. 1, when electrons are supplied to the light-emitting layer 102 by an excitation source (shown in FIG. 4), light 110 is generated in the light-emitting layer 102. The excitation source includes, for example, an electron-emitting device and an electrode disposed on a substrate, and another electrode disposed on a surface of the light-emitting layer 102. The generated light 110 propagates in the positive z-direction (+z) when the light passes through the fine structure 105 and the front plate 101 and is extracted out of the light-emitting device 100. In the present invention, a side towards which the light 110 generated in the light-emitting layer 102 is emitted is defined as a light-emitting side.

In order to improve efficiency in extracting light to an external region, it is required to diffract light 110 generated in the light-emitting layer 102 using the fine structure 105, increase light 111 that propagates at an angle smaller than or equal to the critical angle, and decrease light 112 that propagates at an angle greater than the critical angle.

The reason why high light extraction efficiency can be achieved with the light-emitting device 100 according to the present embodiment is as follows.

That is, in FIG. 1, when the light 110 generated in the light-emitting layer 102 is incident upon the fine structure 105, the light 110 is diffracted into a plurality of rays of light 111 and 112. When the rays of light of zeroth order out of the diffracted rays of light are angled at angles greater than the critical angle at an interface between the front plate 101 and the external region (an outer surface of the front plate 101), the diffracted rays of zeroth order undergo total internal reflection at the interface between the front plate 101 and the external region, and are lost. Out of the rays of light diffracted by the fine structure 105, the rays of light of non-zeroth order and angled at angles smaller than or equal to the critical angle do not undergo total internal reflection and are extracted to the external region. Thus, in order to improve efficiency in extracting light to the external region, it is desirable to increase the intensity of diffracted light of high order other than zeroth order in the fine structure 105.

When light is incident upon the fine structure 105, a phase difference occurs between light having propagated through the elliptical spherical structures 104 and light having propagated through the region 103. The diffraction of light in the fine structure 105 occurs due to the phase difference. The intensity of high order diffracted light increases as the change in phase increases. When the fine structure 105 includes the elliptical spherical structure 104 made of the first medium and having a rotated ellipsoidal shape defined by a path of an ellipse rotated about the major axis as the rotation axis, the change in the phase becomes significant as the ellipticity of the elliptical spherical structure 104 increases because of its significant change in the structure. Here, the ellipticity is a value obtained by dividing the length of the major axis by the length of the minor axis in the elliptical spherical structure 104 having a rotated ellipsoidal shape. In other words, the value is obtained by dividing the diameter in the z-direction (reference sign 108 in FIG. 2B) by the diameter in the x-direction (reference sign 107 in FIG. 2B). After concentrated and diligent study of this issue, the inventors herein have found that the ratio of the intensity of the diffracted rays of light of high order increases as the ellipticity increases. In the light-emitting device 100 according to the present embodiment, by increasing the ellipticity of the elliptical spherical structures 104 included in the fine structure 105, efficiency in extracting light to the external region can be significantly improved.

In order to obtain higher light extraction efficiency, the fine structure 105 preferably generates diffracted rays of light of second or higher order. Since diffracted rays of light of second or higher order have large diffraction angles, even when the light 110 is incident upon the fine structure 105 at a large angle, the light 110 can be diffracted into rays of light that propagate at angles smaller than or equal to the critical angle.

When light is incident upon the fine structure 105, light that satisfies the following expression 1 is generated.

Nᵢₙ sin θᵢₙ+mλ/Λ<Nₒᵤₜ Expression 1.

In expression 1, λ represents a wavelength of the incident light, Nᵢₙ represents a refractive index of an incident side medium, and Nₒᵤₜ represents a refractive index in a region in which the reflected diffracted light or the transmitted diffracted light propagates. θᵢₙ represents an angle formed between the incident direction of the incident light and the z-axis, Λ represents a periodic interval between the elliptical spherical structures 104 each formed of the first medium and having a rotated ellipsoidal shape in the fine structure 105 as the fine structure layer, and m represents the order of diffraction. By setting the periodic interval Λ to 1.0 μm or greater, diffracted light of the second or higher order can be generated even at a wavelength of 700 nm, which is in a visible range and at which generation of diffracted light of a high order is not likely to occur. This can improve efficiency in extracting light to the external region.

Specifically, when the incident angle of light emitted from the light-emitting layer 102 and incident upon the fine structure 105 is greater than the critical angle at the interface between the front plate 101 and the external region, diffracted rays of light of zeroth order undergo total internal reflection at the interface between the front plate 101 and the external region. In order to improve efficiency in extracting light to the external region, it is desirable to avoid total internal reflection. To that end, it is required to increase transmitted diffracted rays of light that propagates at angles smaller than those of zeroth order transmitted diffracted rays of light, and to decrease transmitted diffracted rays of light that propagates at large angles. Increasing the period interval Λ between the elliptical spherical structures 104 increases generation of transmitted diffracted rays of light of non-zeroth orders that propagate at angles greater than the angles at which zeroth-order transmitted diffracted rays of light propagate. This increases losses due to total internal reflection at the interface between the front plate 101 and the external region, thereby decreasing efficiency in extracting light to the external region. In contrast, by setting period interval Λ to smaller than or equal to 3.0 μm, loss caused by total internal reflection can be significantly decreased, and accordingly, efficiency in extracting light to the external region can be maintained at a high level. That is, by setting a lattice constant, which is the periodic interval between the elliptical spherical structures 104 each formed of the first medium and having a rotated ellipsoidal shape in the fine structure 105 of the light-emitting device 100 according to the present invention, from 1 μm to 3 μm, diffracted rays of light of second or higher order can be generated and loss caused by total internal reflection can be decreased, thereby further increasing efficiency in extracting light to the external region.

Next, an example of the fine structure 105 included in the light-emitting device 100 according to the present embodiment will be described. In the fine structure 105 as the fine structure layer illustrated in FIGS. 2A and 2B, each elliptical spherical structure 104 has an elliptical sectional shape the major axis of which extends in the z-direction in a plane parallel to the z-axis, and has a circular sectional shape in a plane parallel to the x and y-axes. That is, of the elliptical spherical structures 104 each one has a rotated ellipsoidal shape defined by a path of an ellipse rotated about the major axis as the rotation axis. The refractive index of the elliptical spherical structure 104 formed of the first medium is 2.2, the refractive index of the second medium that forms the surrounding region 103 is 1.46, the refractive index of the front plate 101 is 1.46, and the refractive index of the light-emitting layer 102 is 1.5. The elliptical spherical structures 104 are arranged such that the center of gravity of each elliptical spherical structure 104 is positioned at the corresponding lattice point of the triangular lattice having the lattice period 106 of 2.3 μm. The fine structure 105 as the fine structure layer is disposed so as to oppose the light-emitting layer 102. The excitation source (shown in FIG. 4) is disposed behind the light-emitting layer 102, and a region behind the excitation source is a vacuum region.

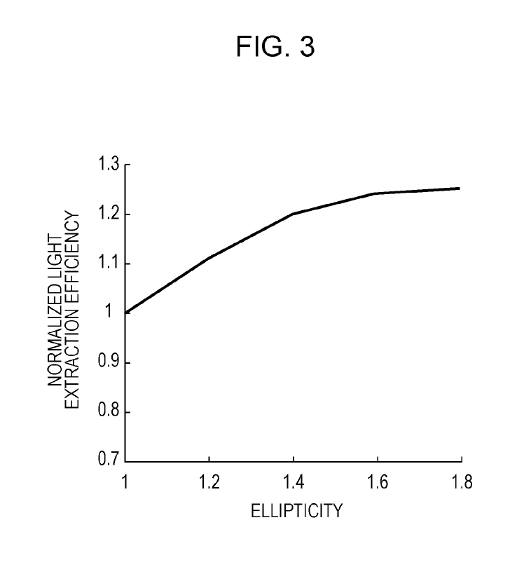

FIG. 3 illustrates light extraction efficiency achieved with the light-emitting device 100 using the above-described fine structure 105 as the fine structure layer. Referring to FIG. 3, the vertical axis represents light extraction efficiency of the light-emitting device 100 including the fine structure 105 provided with the elliptical spherical structures 104 according to the present embodiment. The light extraction efficiency is normalized with respect to the light extraction efficiency of a light-emitting device including a fine structure provided with spherical bodies (that is, ellipticity=1). The horizontal axis represents the ellipticity of the elliptical spherical structure 104 of the fine structure 105.

As illustrated in FIG. 3, by appropriately designing the elliptical spherical structures 104 of the fine structure 105 so as to obtain the ellipticity of greater than 1, light extracting efficiency of the light-emitting device 100 can be improved. With regard to improvement of light efficiency, ellipticity is preferably set to 1.2 or greater. Furthermore, by setting the lattice period 106, which is the periodic interval between the elliptical spherical structures each formed of the first medium and having a rotated ellipsoidal shape in the fine structure 105, from 1.0 μm to 3.0 μm, light extraction efficiency of the light-emitting device 100 can be further improved.

Even when the first medium and the second medium that are part of the fine structure 105 included in the present invention are different from those described in the present embodiment, advantages of the present invention is maintained as long as there is the phase difference between light propagating through the elliptical spherical structure 104 and light propagating through the region 103. Suitably, by increasing the difference between refractive indices of the first medium and the second medium, a more significant change in the phase can be achieved, and accordingly, light extracted to the outside region can be increased. The front plate 101 according to the present embodiment is sufficient if the front plate 101 can protect the light-emitting layer 102 and the fine structure 105 as the fine structure layer, and can allow light generated in the light-emitting layer 102 to pass therethrough. For example, the front plate 101 can be made of plastic. The excitation source can include the electron-emitting device and the electrode disposed on the substrate, and the other electrode disposed on the surface of the light-emitting layer 102. When an electrical field is applied to the electron-emitting device in the above-described structure, electrons are emitted toward the light-emitting layer 102, the light-emitting layer 102 is supplied with electrons, and light is generated in the light-emitting layer 102. Alternatively, the excitation source can have a structure in which the anode and the cathode are respectively disposed between the light-emitting layer 102 and the front plate 101 and between the light-emitting layer 102 and a rear surface. In such a structure, by applying current between both the electrodes and injecting electrons and electron holes into the light-emitting layer 102, light is generated in the light-emitting layer 102. Alternatively, the excitation source can have a cell structure that includes an electrode disposed on a substrate and another electrode disposed on the front surface or the rear surface of the light-emitting layer 102. In such a structure, plasma is generated when current flows in the cell, ultraviolet rays are generated in the cell filled with a gas generating ultraviolet rays, and phosphor particles are irradiated with the ultraviolet rays so as to be excited. The fine structure 105 as the fine structure layer is not limited to the structure illustrated in FIGS. 1, 2A, and 2B. The fine structure 105 can have a structure having different structure parameters. The triangle lattice structure used in the present embodiment has a good structural symmetry and light incident thereupon is less dependent on the azimuth. Thus, the azimuth dependency of the emission intensity from the light-emitting device 100 can be decreased. Alternatively, the fine structure 105 as the fine structure layer can include the elliptical spherical structures 104 each formed of the first medium and having a rotated ellipsoidal shape disposed at aperiodically arranged lattice points. Since light having passed through the fine structure 105 including elliptical spherical structures 104 disposed at aperiodically arranged lattice points has a ring-shaped orientation pattern, the azimuth dependency of the emission intensity from the light-emitting device 100 can be decreased. Arrangement of the elliptical spherical structures 104 of the fine structure 105 is not limited to the triangular lattice shape. For example, the elliptical spherical structures 104 may be arranged in a square lattice shape or a rectangular lattice shape. The light-emitting layer 102 can be formed of a medium other than a first medium that has a refractive index described in the present embodiment. In the present embodiment, the fine structure 105 as the fine structure layer is positioned between the light-emitting layer 102 and the front plate 101. However, arrangement of the fine structure 105 is not limited to this as long as light generated in the light-emitting layer 102 is incident upon the fine structure 105. For example, the light-emitting layer 102 can be positioned between the fine structure 105 and the front plate 101. Alternatively, the fine structure 105 as the fine structure layer can be disposed between the front plate 101 and the external region. With any of the above-described arrangements, light extraction efficiency of the light-emitting device 100 can be improved.

FIG. 4 illustrates an image display apparatus 500 in which a plurality of the light-emitting devices according to the present embodiment are arranged in a surface that is parallel to the front plate. FIG. 4 is a sectional plane view in the xz-plane of the image display apparatus 500 viewed from the positive (+y) y-direction. The image display apparatus 500 includes pixels 510, 520, and 530 that respectively display (emit) red, blue, and green light. The image display apparatus 500 includes a plurality of pixels such as the three pixels 510, 520, and 530 illustrated in FIG. 4 that are arranged in a matrix.

The pixels 510, 520, and 530 respectively include light-emitting layers 512, 522, and 532 and corresponding fine structures 505. In a suitable embodiment, each of the pixels 510, 520, and 530 further includes an excitation source 506. The fine structures 505 as the fine structure layers are positioned between a front plate 501 and the corresponding light-emitting layers 512, 522, and 532. The light-emitting layers 512, 522, and 532 are separated by partitions 503 formed of a medium having an optical absorbing property. The excitation sources 506 oppose the front plate 501 and the light-emitting layers 512, 522, and 532. The front plate 501 is formed of a medium that is transparent to visible light, for example, formed of glass. The light-emitting layers 512, 522, and 532 of the pixels 510, 520, and 530 respectively include phosphors that generate light at wavelengths corresponding to red, blue, and green.

The fine structures 505 as the fine structure layers include elliptical spherical structures 504 and the second medium. The elliptical spherical structures 504 are each formed of the first medium (first material) and have a rotated ellipsoidal shape defined by a path of an ellipse rotated about the major axis as the rotation axis. The second medium surrounds the elliptical spherical structures 504 formed of the first medium. The second medium has a refractive index different than that of the second medium. That is, each elliptical spherical structure 504 forms a first medium portion that is surrounded by the second medium in the in-plane direction of the fine structure 505 as the fine structure layer. In addition, the fine structure 505 has a periodic refractive index distribution in the xy in-plane direction and has a lattice period, which is the periodic interval between the elliptical spherical structures 504. The periodic interval preferably ranges from 1.0 μm to 3.0 μm. The pixels 510, 520, and 530 include the respective fine structures 505, and each fine structure 505 is formed of the same media (same materials) and has the same structure.

Excitation sources 506 form a layer and include respective units for injecting electrons into the light-emitting layers 512, 522, and 532. Each excitation source 506 includes, for example, an electron-emitting device and an electrode disposed on a substrate, and a transparent electrode disposed on the surface of each of the light-emitting layers 512, 522, and 532. When electrical fields are applied to the electron-emitting devices in the above-described structure, electrons are emitted toward the light-emitting layers 512, 522, and 532, the light-emitting layers 512, 522, and 532 are supplied with electrons, and light is emitted. The generated light passes through the fine structures 505 and the front plate 501, is extracted out of the image display apparatus 500, and used as light for display.

In the image display apparatus 500 of the present embodiment, the lattice period is set from 1.0 μm to 3.0 μm. By appropriately setting the refractive indices of the first medium and the second medium included in the fine structure 505 and the filling ratio and the shape of the elliptical spherical structures 504 included in the fine structure 505, light extraction efficiency of each of the pixels 510, 520, and 530 can be improved. By improving light extraction efficiency of the pixels 510, 520, and 530, the intensity of the display light of the image display apparatus 500 can be increased. Thus, the image display apparatus 500 that displays an image with high contrast can be obtained.

In the image display apparatus 500 according to the present embodiment, variations in display brightness among the pixels 510, 520, and 530 can be small even when the pixels 510, 520, and 530 use the fine structures 505 formed of the same medium and having the same structure. In the xy-plane of the fine structure 505, the period in the refractive index distribution is 1.0 μm or longer, and rays of light incident upon the fine structure 505 from a variety of directions are divided into many diffracted rays. The intensity of each diffracted ray of light is small, and variations in the intensity due to variations in the wavelengths of the incident light are small. Accordingly, even when the wavelengths of rays of light incident upon the fine structure 505 vary, variations in the brightness of the display light are small. Thus, a characteristic of brightness can be achieved, in which differences in brightness are small among the pixels 510, 520, and 530. For this reason, the structures of the pixels 510, 520, and 530 need not be different from each other. This facilitates fabrication of the image display apparatus 500.

Alternatively, the image display apparatus 500 according to the present embodiment can have different fine structures 505 for the respective pixels 510, 520, and 530. Alternatively, the fine structure 505 provided for one of the pixels 510, 520, and 530, which respectively corresponds to red, blue, and green, and the fine structures 505 provided for other pixels can be different from each other. This allows the image display apparatus 500 to display an image with high contrast by further increasing effects of suppressing specular reflected light and diffuse reflected light and effects of increasing display light compared to a case in which the fine structures 505 provided for the pixels 510, 520, and 530 have the same structure. Alternatively, the fine structures 505 provided for the pixels 510, 520, and 530 can have different thicknesses from each other in the yz-section. Alternatively, the lengths of the lattice periods and the shapes of the elliptical spherical structures 504 can be differently set for the pixels of individual colors. The light-emitting layers 512, 522, and 532 can each have phosphor particles scattered in a medium having the refractive index the same as that of the phosphor particles. With such a structure, scattering of light due to the difference between the refractive indices at boundaries of the phosphor particles and the surrounding medium can be decreased, and accordingly, reflection of external light can be decreased. By disposing the fine structures 505 between the light-emitting layers 512, 522, and 532 and the front plate 501 as in the present embodiment, external light that is incident upon the image display apparatus from the external region can be reflected as a plurality of scattered rays of light. Thus, the intensity of reflected external light that is incident upon the eyes of an observer can be decreased. By decreasing the intensity of reflected external light and increasing display brightness of the pixels, the image display apparatus 500 that displays an image with high contrast even in a bright environment can be obtained.

In the image display apparatus 500 according to the present embodiment, the fine structures 505 as the fine structure layer are positioned between the light-emitting layers 512, 522, and 532 and the front plate 501. However, arrangement of the fine structures 505 is not limited to this as long as light generated in the light-emitting layers 512, 522, and 532 is incident upon the fine structures 505.

### First Example

Examples according to the present invention will be described below. A light-emitting device illustrated in FIG. 1 is fabricated as a first example.

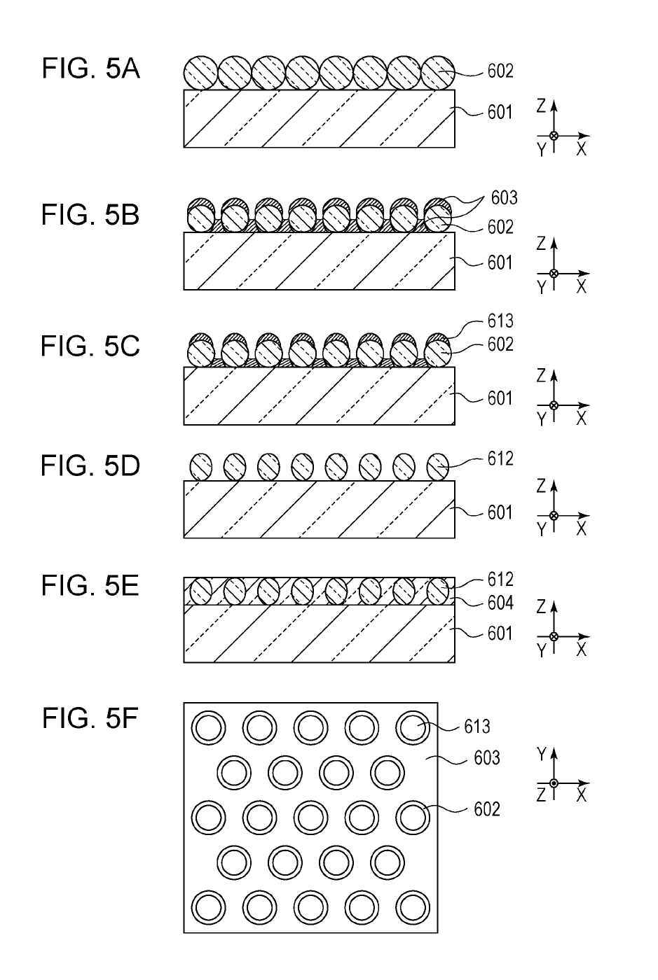

The light-emitting device 100 is fabricated by arranging fine balls (spheres) on the front plate 101, performing a process in which the arranged fine balls are changed into elliptical spheres so as to form the fine structure 105 as the fine structure layer, and then the light-emitting layer 102 is stacked. The method of fabricating the light-emitting device 100 will be described below with reference to FIGS. 5A to 5F. FIGS. 5A to 5F illustrate a process of fabricating the fine structure 105 as the fine structure layer, in which FIGS. 5A to 5E illustrate sectional views of the front plate 101 and the fine structure 105 in the xz-plane. FIG. 5F illustrates a top view of a structure illustrated in FIG. 5C in the xy-plane.

### Process of Arranging Fine Balls

As illustrated in FIG. 5A, fine balls 602 having a particle diameter from 1.0 μm to 3.0 μm and formed of the first medium are arranged on a substrate 601. In the present example, the term particle diameter refers to the diameter of the fine ball. By adjusting the particle diameter, an interval between the adjacent elliptical spherical structures 104 can be appropriately set. There are known methods that can be used as a method of arranging the fine balls. For example, the following method can be used. That is, a particle dispersion in which the fine balls 602 dispersed as a solid dispersion medium are dispersed in a liquid dispersion medium is applied over the substrate 601 to which a fixing layer (not shown) has been applied, a fixing process is performed, and then the liquid dispersion medium and the excess fine balls 602 are removed.

Although the fine balls 602 are not particularly limited a particular first medium, it is preferable that the first medium is substantially transparent to light generated in the light-emitting layer 102. For example, the fine balls 602 can be formed of a metal oxide such as SiO₂ or TiO₂, or a metal nitride such as SiN.

### Process of Forming Ellipsoids

After the fine balls 602 have been arranged, the size of each fine ball 602 is decreased by isotropic etching as illustrated in FIG. 5B. Then a thin film 603, which is formed of a different medium from the first medium, is deposited on the fine balls 602. As a method of depositing the thin film 603, a known method such as sputtering or an evaporation method can be used. The length of the major axis of each elliptical spherical structure 104 can be controlled in accordance with the decreased size of the fine ball 602.

As illustrated in FIG. 5C, part of the thin film 603 is removed by an etching process, and cap structures 613 are formed on the fine balls 602. As an etching method, an etching method with which only part of each fine ball 602 can be exposed can be sufficient.

Next, as illustrated in FIG. 5D, the cap structures 613 are used as masks and etching is again performed so as to form an ellipsoid 612 by changing the shapes of the fine balls 602 into elliptical spheres. As an etching method, a method is sufficient if portions where the fine balls 602 are exposed illustrated in the top view in FIG. 5F can be processed. For example, anisotropic etching can be used. The length of the minor axis of each elliptical spherical structure 104 can be controlled by appropriately controlling the size of the cap structure 613 and etching conditions. Thus, the first medium is processed into the rotated ellipsoidal shapes. In the present example, the process illustrated in FIG. 5C and the process illustrated in FIG. 5D are described as separate processes. However, the method is not limited to this. By appropriately setting the ratios of the etch rates for the thin film of the thin film 603, the medium included in the thin film 603, and the fine ball 602, and by using isotropic etching, the processes illustrated in FIGS. 5C and 5D can be integrated into one process.

After the shapes of the fine balls 602 have been changed into ellipsoids, the periphery of each ellipsoid 612 is filled with the second medium, which has a refractive index different from the refractive index of the first medium, so as to form a layer 604. In order to form the layer 604, a known method such as the spin coating, bar coating, or sputtering can be used. The second medium that forms the layer 604 is not particularly limited as long as the second medium has a refractive index different from that of the first medium. The second medium is suitably a medium that is transparent to light generated in the light-emitting layer 102. For example, for the second medium an oxide such as SiO₂ or TiO₂, a nitride such as SiN, or a spin-on glass material or the like can be appropriately used. After the layer 604 has been formed, the light-emitting device 100 is formed by stacking fine structure onto the light-emitting layer 102.

In the present example, the elliptical spherical structures 104 are formed by the process of forming ellipsoids after the fine balls 602 have been arranged. By using the process of arranging fine balls, the arrangement of the fine balls 602 that is uniform over a large area is achieved at a low cost. Furthermore, using the process of forming ellipsoids, the light-emitting device 100 that exhibits high light extraction efficiency is fabricated. As described above, with the fabrication method of the present example, the light-emitting device 100 that exhibits high light extraction efficiency and has a large area is fabricated.

With respect to the fine structure 105 as the fine structure layer, the ratio of the intensity of the high-order diffracted light to the intensity of all the diffracted light reaches the maximum when the filling ratio of an area occupied by the first medium is 0.5. The filling ratio here is that of a section in which the xy in-plane sectional area of the elliptical spherical structure 104 is the maximum. When considered in combination with the method of fabricating the present example, in order to obtain the light-emitting device 100 that exhibits high light extraction efficiency, the ellipticity (a value obtained by dividing the length of the major axis by the length of the minor axis) is preferably set to a value smaller than 1.43.

### Second Example

In a second example, the fine structure 105 as the fine structure layer of the light-emitting device 100 having a large area is fabricated in a single process at a low cost. Also in the present example, the light-emitting device 100 illustrated in FIGS. 1, 2A, and 2B is fabricated by performing the process of arranging fine balls, performing a process in which the arranged fine balls are changed into ellipsoids, and then the light-emitting layer 102 is stacked.

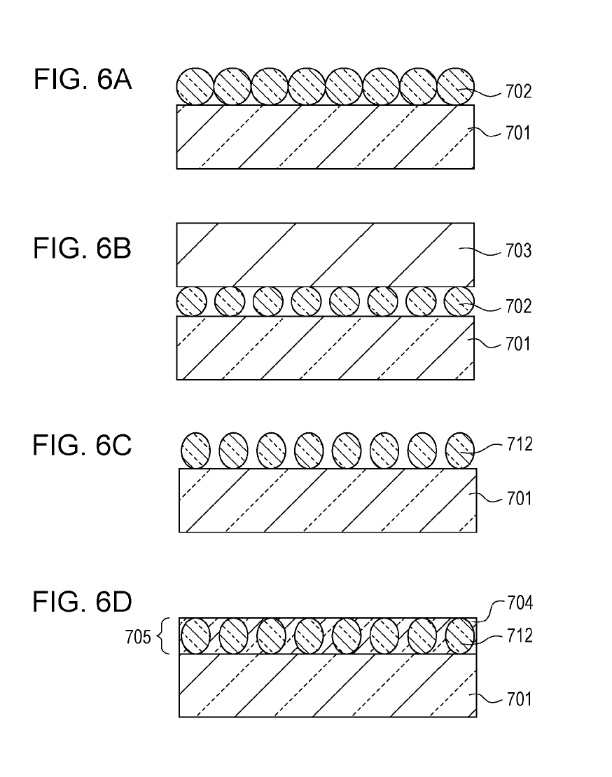

The method of fabricating the light-emitting device 100 will be described below with reference to FIGS. 6A to 6D. FIGS. 6A to 6D are sectional views of the front plate 101 and the fine structure 105 in the xz-plane, illustrating processes of fabricating the fine structure 105 as the fine structure layer.

### Process of Arranging Fine Balls

As illustrated in FIG. 6A, fine balls 702 formed of the first medium are arranged on a substrate 701. The method of arranging the fine balls 702 can be a method similar to the method used in the first example.

### Process of Forming Elliptical Sphere

After the fine balls 702 have been arranged, the size of each fine ball 702 is decreased by isotropic etching, and then a substrate 703, to which a fixing layer (not shown) has been applied, is bonded to the fine balls 702 as illustrated in FIG. 6B.

Next, in a pulling process illustrated in FIG. 6C, the substrate 703 is pulled away in a direction in which a gap between the substrates 701 and 703 increases. This causes each fine ball 702 to deform into an ellipsoidal shape. The fine balls 702 become ellipsoids when the substrate 703 is removed. After the shapes of the fine balls 702 have been changed into ellipsoids 712, the periphery of each fine ball 702 is filled with the second medium, which has a different refractive index from the first medium, so as to form a region 704. The second medium that forms the region 704 is not particularly limited as long as the second medium has a different refractive index from that of the first medium. The second medium is suitably a medium that is transparent to light generated in the light-emitting layer 102. For example, the second medium can use a metal oxide such as SiO₂ or TiO₂, a metal nitride such as SiN, or a spin-on glass material or the like. By considering the contraction ratio of the fine balls 702 in the pulling process, and appropriately controlling the sizes of the fine balls 702, the length of the minor axis of the elliptical spherical structure 104 can be controlled. After that, the light-emitting device 100 is formed by forming the light-emitting layer 102 on the substrate 701.

In the present example, the elliptical spherical structures 104 are formed by the process of forming ellipsoids after the fine balls 702 have been arranged. By using the process of arranging fine balls, the arrangement of the fine balls 702 that is uniform over a large area is achieved at a low cost. Furthermore, using the process of forming ellipsoids, the light-emitting device 100 that exhibits high light extraction efficiency is fabricated. By using the process of forming ellipsoids used for the present example, the elliptical spherical structures 104 having a high ellipticity can be formed. By using the elliptical spherical structures 104 having a high ellipticity, the change in the phase of light having passed through a fine structure 705 can be significant. Thus, the light-emitting device 100 can have a structure with which the light-emitting device 100 exhibits further increased light extraction efficiency.

As described above, with the fabrication method of the present example, the light-emitting device 100 that exhibits high light extraction efficiency and has a large area is fabricated at a low cost.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-210904 filed Sep. 21, 2010, which is hereby incorporated by reference herein in its entirety.

What is claimed is:

1. A light-emitting device comprising:
a light-emitting layer; and
a fine structure layer that opposes the light-emitting layer, light generated in the light-emitting layer passing through the fine structure layer,
wherein the fine structure layer includes
a plurality of first medium portions, and
a second medium region, the second medium region having a refractive index different from a refractive index of the first medium portions,
wherein the plurality of first medium portions are each surrounded by the second medium region in an in-plane direction of the fine structure layer,
wherein each first medium portion is formed to have a rotated ellipsoidal shape, the rotated ellipsoidal shape having a major axis that extends in a direction perpendicular to a surface that opposes the light-emitting layer, the rotated ellipsoidal shape being defined by a path of an ellipse rotated about the major axis as a rotation axis.

2. The light-emitting device according to claim 1,
wherein the plurality of first medium portions are arranged in a triangle lattice shape in the surface, and a lattice constant of the triangle lattice shape is from 1 μm to 3 μm.

3. The light-emitting device according to claim 2,
wherein each of the plurality of first medium portions is arranged such that the center of gravity thereof is positioned at a corresponding lattice point in the triangle lattice shape.

4. The light-emitting device according to claim 1,
wherein each of the plurality of first medium portions is aperiodically arranged in the surface.

5. The light-emitting device according to claim 1,
wherein the ellipticity of the rotated ellipsoidal shape is smaller than 1.43.

6. The light-emitting device according to claim 1, further comprising:
a front plate, light generated in the light-emitting layer passing through the front plate,
wherein the fine structure layer is positioned between the light-emitting layer and the front plate.

7. The light emitting device according to claim 6,
wherein the light generated in the light-emitting layer and passing through the front plate is refracted at an exit surface of the front plate at an angle equal to or less than the critical angle.

8. An image display apparatus comprising:
a plurality of light-emitting devices arranged in a matrix shape,
wherein each light-emitting device comprises the light-emitting device according to claim 1.
